(19) United States
(12) Patent Application Publication
(10) Pub. No.: US 2014/0222621 A1
(43) Pub. Date: Aug. 7, 2014

(54) METHOD OF A WEB BASED PRODUCT CRAWLER FOR PRODUCTS OFFERING

(71) Applicant: Hirenkumar Nathalal Kanani, Surat (IN)

(72) Inventor: Hirenkumar Nathalal Kanani, Surat (IN)

(21) Appl. No.: 14/130,913

(22) PCT Filed: May 17, 2012
(86) PCT No.: PCT/IN2012/000354

§ 371 Date: Mar. 31, 2014

(30) Foreign Application Priority Data
Jul. 6, 2011 (IN) 1956/MUM/2011

(51) Int. Cl. G06Q 30/06

(52) U.S. Cl. CPC G06Q 30/0625
USPC 705/26.62

(57) ABSTRACT

The invention relates to a method of a product crawler having relatively simple automatic program that systematically fetches all the hyperlinks from the view source of the web pages of specific URL or website that has been registered on the service provider's database server through a service provider's website and therein the said service provider's website of which a product search engine being embedded for searching the products that has been offered. The product crawler further analyses the said hyperlinks and then crawls and extracts only their product information related data such as title, description, image, price, model number and save them in the service provider's database to produce finally a product related data index in the search engine repository to display the product related information for products offering and marketing during when user makes substantially same product related query from the service provider's website.

### FIELD OF THE INVENTION

The present invention relates to the field of crawling internet web pages and its contents. More particularly, this invention relates to a web crawler for fetching, analysing and automatically crawling the specific contents from a registered merchant's website for offering and marketing the product related results that span categories in response to user queries via the search engine system on the service provider's website.

### BACK GROUND AND PRIOR ART OF THE INVENTION

The internet is worldwide network of Computers linked together by various hardware communication links all running a standard suite for protocol known as TCP/IP (Transmission Control Protocol/Internet Protocol). Computer networks, particularly the internet, provide increasingly important markets for goods (or products) and services. Currently, the internet extends to millions of computers in more than a hundred countries. One service that uses the internet is the World Wide Web (the “Web”). The web is a system of Internet servers that support documents formatted in a markup language called Hypertext Markup Language (“HTML”). A huge number of web servers support HTML documents, commonly referred to as web pages, containing various types of information including text, graphics, and video and audio files. Typically, Web pages are viewed on computers using web browser software, e.g., NETSCAPE NAVIGATOR or MICROSOFT′S INTERNET EXPLORER; however, web pages may also be accessed by other devices, such as personal digital assistants, mobile phones, etc.
a. Currently the web is a very efficient tool for searching product ideas and information. These developments includes the increased availability of both commercial and residential high-speed internet connections, improvements in the capabilities of browser, improvements in search services that allow users to quickly identify sources of useful information (product related) and the dramatic increase in the amount of information (product data) that is available to users. As a result, a large and vibrant web-based marketplace has emerged.
b. Particularly, in the retail sector, multiple merchants (or sellers) often offer the same or similar products such that consumers can find (or search) the same product available for sale on several different retail websites. Known examples of online product search systems, such as those found at the web sites Froogle.com, pricegrabber.com require the users to first searching a product of interest, then go to a dedicate web site and also viewing specific information about the products and user-specified products can be purchased. The present invention satisfies this need.
c. The need for automatically crawling the internet web pages of the merchant's website for the product offering or product marketing from the service provider's website through the search engine system is particularly critical in the online business marketing techniques in addition with generating online purchase orders electronically through a electronic source system by means of after entering the product information to be purchased into the said system, searching for the matched items looking for from the database of the system and finally generating order lists for the purchasing from websites of different merchants who all are the registered customers of the service providers. Many product crawling programs for the aforesaid task has been configured conventionally, for extends US 20020078136 in which the one embodiment, discloses an improved method for crawling a web site is provided. At least one page of the web site has a reference for executing by a browser to produce an address for a next page. The website is crawled by a crawler program, which includes querying the web site server. The crawler parses such a reference from one of the web pages, and sends the reference to an applet running in the browser. The address for the next page is determined by the browser responsive to the reference. The address is then sent to the crawler. In an application of the improved crawler, the crawler is used for reducing dynamic data generation on the website server. In this application, at least some of the web pages are dynamically generated responsive to the crawler queries. The server generated web pages are processed to generate corresponding processed versions of the web pages, so that the processed versions can be served in response to future queries, reducing dynamic generation of web pages by the server. And US20060167864 discloses a search engine system that assists users in locating web pages from which user-specified products can be purchased. Web pages located by a crawler program are scored, based on a set of criteria, according to likelihood of including a product offering. A query server accesses an index of the scored web pages to locate pages that are both responsive to a user's search query and likely to include a product offering. In one embodiment, the responsive web pages are listed on a composite search results page together with responsive products included in a product catalog.
d. However, in the aforesaid patent applications the programs are programmed such that it crawls all the links of the web pages of website of the merchant and locates the same web pages for the online product offerings and marketing through the search engine for the online purchasing and that cause the overloading of the service provider's database server and whereas, the present invention discloses an automatic product crawler which does the same task but instead of crawling whole links of the web page it crawls only the specific product related contents from the web page and thereby saves time and increases the efficiency to quick display of the product's search related information from the service provider's database server.

### OBJECT OF THE INVENTION

The main object of this invention is to provide a fully automated website crawler to identify and then fetching all the links of web pages of given site and then analysing and finally crawling and extracting only the product related data from those links and store product related data information into the service provider's database.
a. Still another object of this invention is to have a feature through which it is possible to implement any individual product data gathering tasks without data size limitations in the minimum amount of time and viewing internet search engines.
b. Further object of this invention is to provide a method that assists for efficiently and quickly displaying the product results of a multiple-category search to a user's search query through a search engine system.

### SUMMARY OF THE INVENTION

The present invention relates to a method of a product crawler having relatively simple automatic program that systematically scans or fetches all the hyperlinks corresponds to href tag from the view source of the internet pages (web pages) of specific URL or website of a merchant that has been registered on the service provider's website and therein the said service provider's website of which a product search engine being embedded for searching the products that has been offered. The said program further analyses said hyperlinks and then crawls their specific product information related data such as title, description, image, price and model no (if available) that available from the web pages and store in the service provider's database. Hence, a computer program programmed in the service provider's database for crawling his customer's (merchant's) products fetches automatically all the links across the web pages of merchant's website that is registered or submitted and analysing the said links of the web pages by reading page view source to crawl only specific product related data contents to produce finally a product related data index in the search engine repository and such product related information will be displayed for products offering and marketing when user makes substantially same product related query in the service provider's website.

### DETAIL DESCRIPTION OF THE DRAWINGS

FIG. 1 (a) illustrates a flow chart depicting the former steps in the first process of product crawling along with the registration process.

FIG. 1 (b) illustrates a flow chart depicting the steps that is in continue with the FIG. 1 (a).

FIG. 2 illustrates a flow chart indicating the steps in the second process of the product crawling.

FIG. 3 (a), FIG. 3 (b) and FIG. 3 (c) illustrates flow diagram depicting overall process of the product crawling combining said first process and second process and in which FIG. 3 (b) is in continue with the FIG. 3 (a) and FIG. 3 is in continue with the FIG. 3 (b).
a. Exemplary embodiments of the invention are discussed in detail below while specific exemplary embodiments are discussed, it should be understood that this is done for illustration purpose only. A person skilled in the relevant art will recognize that other components and configuration can be used without parting from the spirit and scope of the invention.

### DETAIL DESCRIPTION OF THE INVENTION

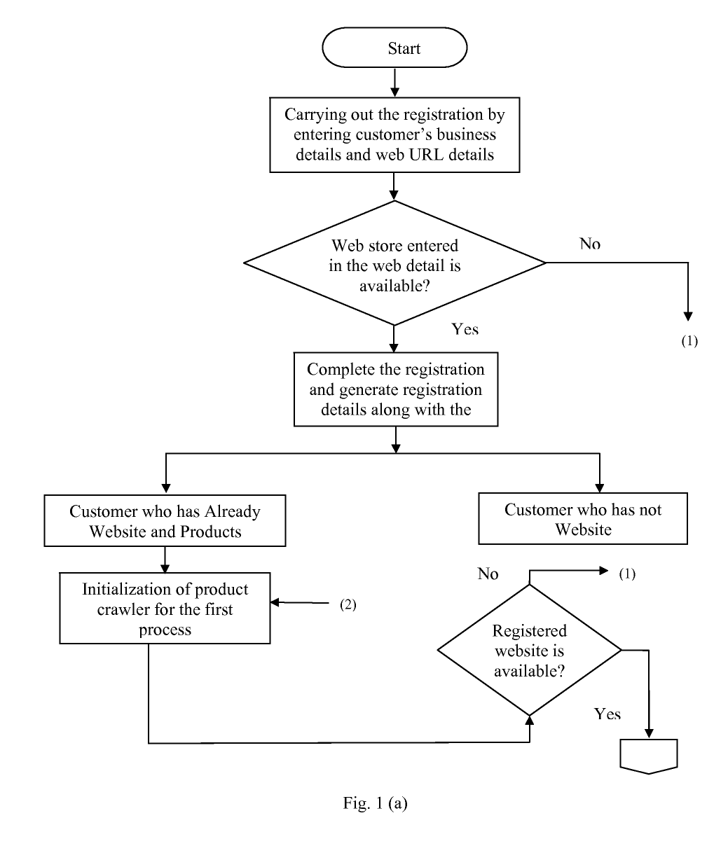

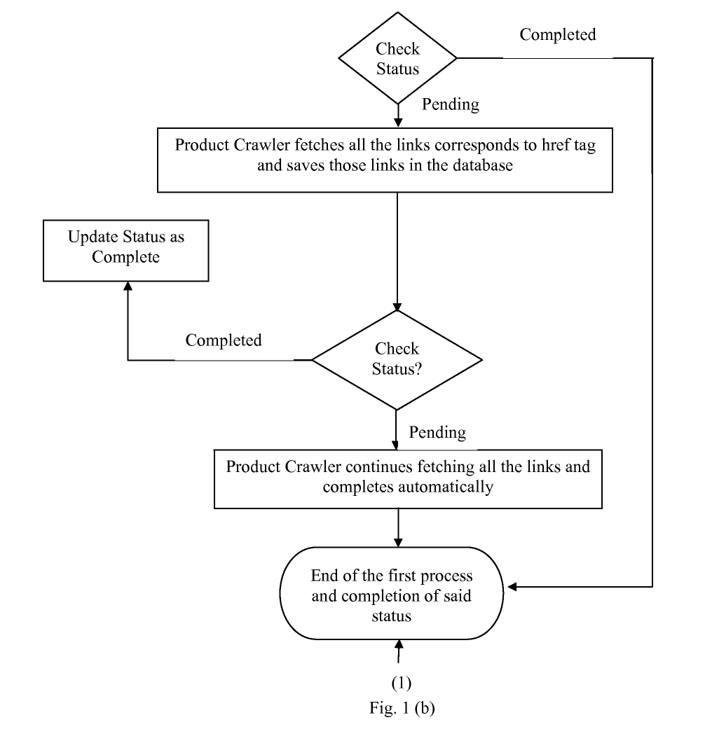

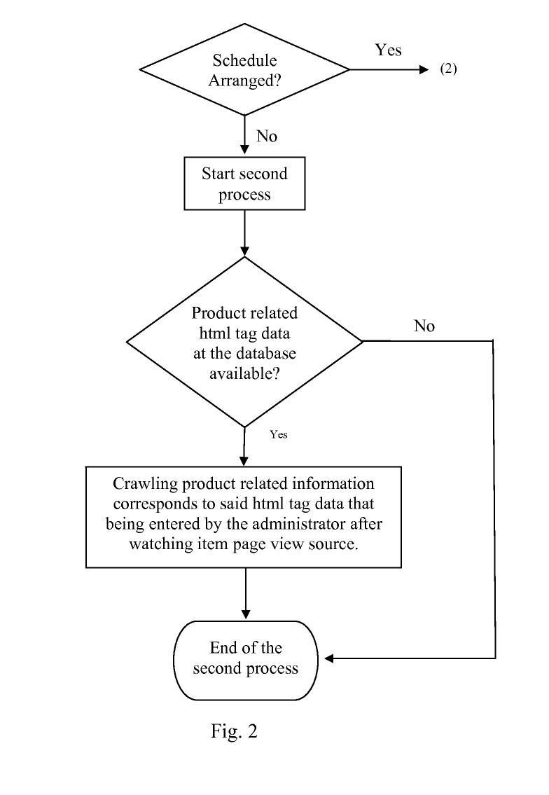

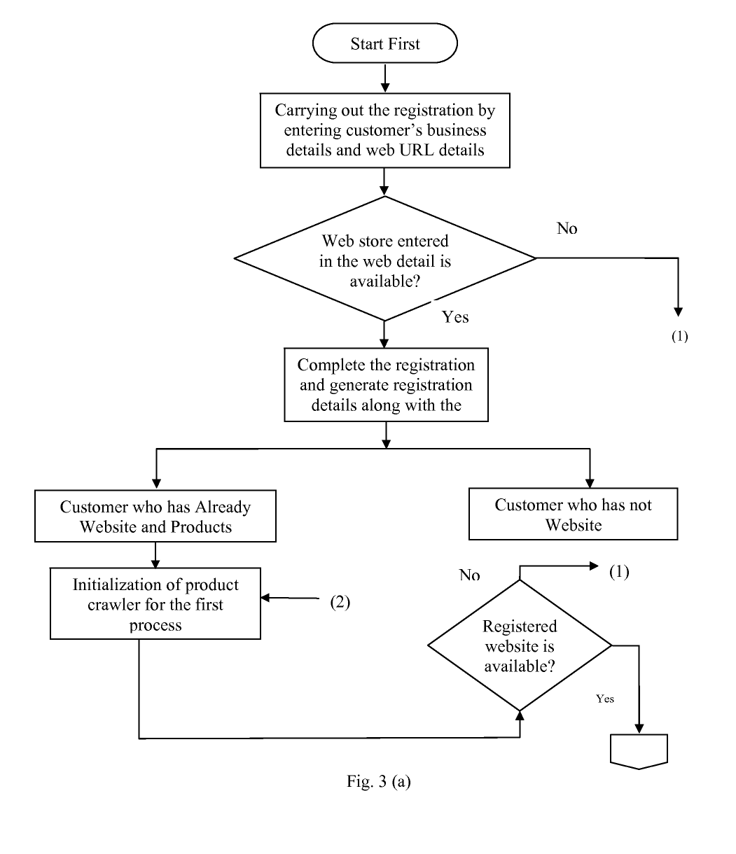

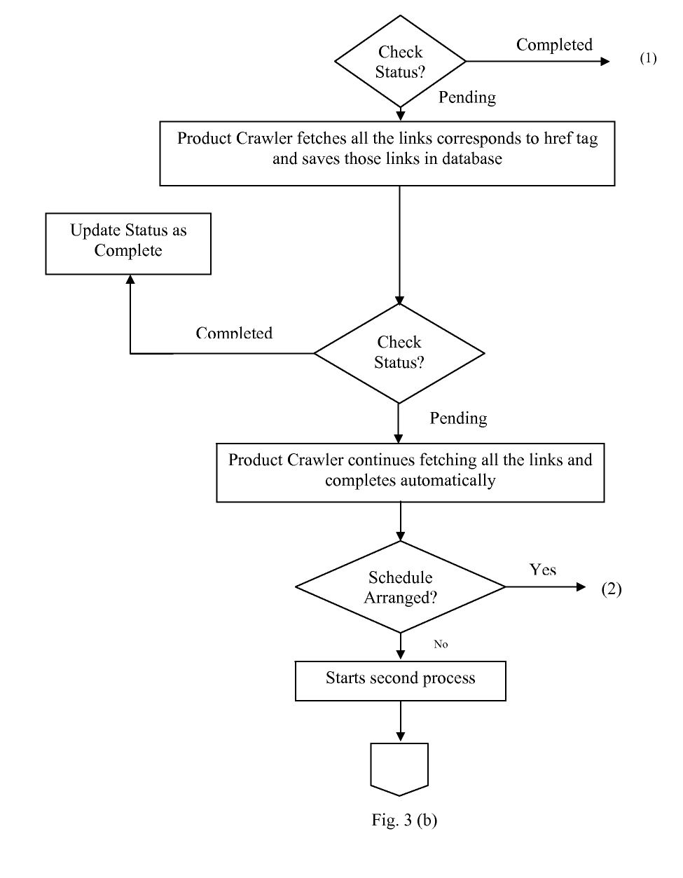

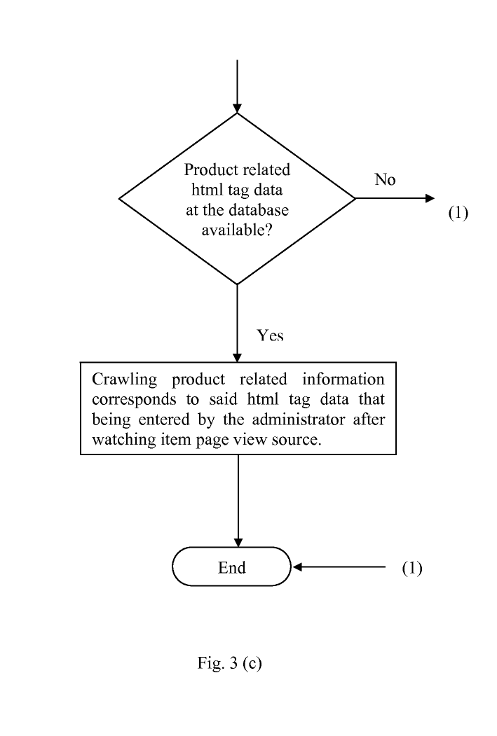

This present invention discloses a method for a product crawling for offering and marketing the customer's (merchant's) products through the service provider's search engine that being coupled with the service provider's database server, against the response to the queries of the users searching for the required products from the service provider's website. As directed in FIG. 1 (a), before initiating the crawler program for said product crawling any interested person or merchant whose products to be crawled must carry out the registration of his business and web URL details on the service provider's website by entering his name, address, website (URL) and a web store name for creating a new web store in the service provider's database server. Successful completion of said registration on the service provider's website would automatically generate and display the registration details along with the web store name for the customer's record when said entered web store name is available in the database. After the completion of the registration details the merchant needs to select the options for the availability of his own website and however, the present scenario works for only those customers who have the websites. Now, when crawler program is initialized for the first process, the product crawler automatically performs the following tasks in a prescribed sequence which is as follows, as depicted in FIG. 1 (a). The crawler first of all checks, in the first process, the availability of the registered website of the merchant in the service provider's database and if such website is not available then there is an end of the crawling process for that particular registration. Whereas, if the registered website is available then the product crawler automatically checks a status for initiating the link fetching from webpage of the registered website, as depicted in FIG. 1 (b), and if said status identified by the crawler is completed then the first process comes to an end and whereas, if said status identified by the crawler is pending then the crawler processing ahead and picks up the view source of the web pages of the corresponding website and fetches all the links corresponds to href (hypertext reference) tag in the html page of the view source and saves the said links into the service provider's database. After doing so, the crawler will check a status for completion of said link fetching and if such status is completed then the status is automatically updated as completed and whereas if the status is pending then the crawler will complete the fetching of all the said links and thereby the first process of product crawling comes to an end and simultaneously said status is completed.
a. As there is a chance of new updated product information data in the customer's website after being the first process of product crawling is completed, as depicted in FIG. 2, a provision for arranging schedule option is provided. Hence, the second process of product crawling depends upon the schedule arrangement. After the ending up of the first process, first of all, the product crawler checks whether schedule for going back to the first process for recrawling is arranged or not and if it is yes then crawler would continue the first process otherwise after fetching all the links from source code, the second process of product crawler will start automatically. At this stage, the second process further depends on the availability of product related html tag data corresponds to specific database fields in the database server such as title of the product, description of the product, image of the product, price of the product and model no (if any) that being entered by the administrator before starting of the second process. The said administrator manually adds said product related html tag data corresponds to specific database field into the database after watching item page view source for product crawling. Hence, in the second process if the product crawler finds said entered product related data in the database which is filled by the administrator then the product crawler crawls links of only such product related html tag data corresponds to the entered database fields instead of crawling all the links that has been fetched and saved in the first process and finally save only those specific data in the database server to display the product related information of said fields for products offering and marketing on the service provider's website. Whereas, if the product crawler do not find the said product related html tag data then there will be an end of the second process. Hence, after the end of the second process of web crawler, the product related database fields such as title, description, price, image information of the registered website and model no (if available) will be indexed for repository for displaying the product related information through search engine for products offering and marketing during when the user searches his desired products on the service provider's website.
b. Hence, recapitulating the whole process, it can be said that the product crawler is programmed such that even in the first process of product crawling it fetches all the href tag links from the html pages of the source code of web pages of the merchant or customer, the product crawler crawls only those product related links in the second process of product crawling which are entirely related to product related html tag data corresponds to specific database fields available in the service provider's database such as title, description, image, price and model no (if any) to display the product related information of said fields in the indexed form for products offering and marketing on the service provider's website against the response to user's query during his product searching from the service provider's website and in the FIGS. 3 (a), 3 (b) and 3 (c) such two process of product crawling has been shown systematically and sequentially with substantial steps.
c. While, the invention has been described with respect to the given embodiment, it will be appreciated that many variations, modifications and other applications of the invention may be made. However, it is to be expressly understood that such modifications and adaptations are within the scope of the present invention, as set forth in the following claims.

What is claimed is:

1. A Method of a Web Based Product Crawler for Products Offering and marketing the products of a customer to store a product related information data available in the customer's website on to a service provider's database and which being coupled with a search engine comprising the following steps;
a. carrying out a registration of the customer's business details and web URL details by entering customer's name, address, website (URL) and web store name for creating a new web store in the service provider's database server before initiating a crawler program of said product crawler;
b. completing the registration and then generating and outputting the registration details along with said web store name for the customer's record when said web store name is available;
c. selecting the available option for the customer having registered website;
d. initiating the crawler program of said product crawler to execute a first process and wherein said first process includes the following steps;
e. checking availability of the registered website of the customer in the service provider's database and when said website is not available then ending the first process;
f. in case when said registered website is available for crawling then checking and identifying a status for initiating the link fetching from webpage of the registered website and when said status identified by the product crawler is completed then ending the first process;
g. fetching all the links corresponds to href (hypertext reference) tag in the html page of said view source during when status identified by the crawler program is pending;
h. saving said fetched links into the service provider's database;
i. checking a status for completion of said link fetching and when the status is completed then updating the status as complete;
j. completion of the fetching said links and ending the first process and there by completing the said status during when said status for fetching is identified by the crawler is pending;
k. checking the schedule arrangement for going back to initiate the first process for recrawling, as there is a chance of new updated product information data in the customer's website and when such schedule is arranged then continuing the first process otherwise starting the second process of the product crawler automatically;
l. checking availability of product related html tag data corresponds to specific database fields in the service provider's database such as title, description, image, price and model no (if any) and when said data is not available then terminating the second process;
m. crawling the links of said product related database fields during when said html tag data is available in the service provider's database for the product crawling;
1. wherein into the service provider's database said specific database field being entered before starting of the second process;
n. saving only those said entered specific database fields in the service provider's database server to produce product related data index for repositioning and displaying the product related information through the search engine for said products offering and marketing during when a user searches his desired product from the service provider's website;
o. ending of the second process and thereby terminating the product crawler eventually.

2. A Method of a Web Based Product Crawler for Products Offering as claimed in claim 1, wherein the customer means any merchant and the service is provided for only the registered customer having website.

3. A Method of a Web Based Product Crawler for Products Offering as claimed in claims 1 to 3 is substantially as herein described with reference to the forgoing description and accompanying drawings.
